(19) United States
(12) Patent Application Publication
(10) Pub. No.: US 2012/0162097 A1
(43) Pub. Date: Jun. 28, 2012

(54) MICROCAPSULE HAVING HEAT-RESISTANCE, TOUCH PANEL CONTAINING THE SAME AND METHOD FOR MANUFACTURING TOUCH PANEL

(75) Inventors: Sang Hwa Kim, Gyunggi-do (KR); Ji Soo Lee, Gyunggi-do (KR); Youn Soo Kim, Seoul (KR); Jong Young Lee, Gyunggi-do (KR); Yong Hyun Jin, Seoul (KR)

(73) Assignee: SAMSUNG ELECTRO-MECHANICS CO., LTD., Gyunggi-do (KR)

(21) Appl. No.: 13/043,632

(22) Filed: Mar. 9, 2011

(30) Foreign Application Priority Data
Dec. 27, 2010 (KR) 102010-0135610

(51) Int. Cl. G06F 3/041; H01B 1/12

(52) U.S. Cl. 345/173; 252/500

(57) ABSTRACT

Disclosed herein is a microcapsule having heat-resistance in a core-shell structure, including: a conductive polymer core; and a shell made of polyimide and partially enclosing the conductive polymer core. The core-shell structure in which a partial polyimide shell is formed on the conductive polymer core is formed, thereby making it possible to improve the heat-resistance of the conductive polymer. In addition, a transparent electrode having improved heat-resistance is used to minimize a change rate in sheet resistance due to a high temperature, such that electrical reliability of a touch panel is improved, thereby making it possible to improve accuracy of an operation.

### CROSS REFERENCE TO RELATED APPLICATION

This application claims the benefit of Korean Patent Application No. 10-2010-0135610, filed on Dec. 27, 2010, entitled “Microcapsule Having Heat-Resistance, Touch Panel Containing the Same and Method for Manufacturing Touch Panel”, which is hereby incorporated by reference in its entirety into this application.

### BACKGROUND OF THE INVENTION

1. Technical Field

The present invention relates to a microcapsule having heat-resistance, a touch panel containing the same and a method for manufacturing the touch panel.

2. Description of the Related Art

In accordance with the development of computers using a digital technology, devices assisting computers have also been developed, and personal computers, portable transmitters and other personal information processors execute processing of text and graphics using a variety of input devices such as a keyboard and a mouse.

While the rapid advancement of an information-oriented society has been widening the use of computers more and more, there have been occurring the problems of it being difficult to efficiently operate products using only the keyboard and mouse as being currently responsible for the input device function. Thus, the demand for a device that is simple, has minimum malfunction, and has the capability to easily input information is increasing.

Furthermore, current techniques for input devices exceed the level of fulfilling general functions and thus are progressing towards high reliability, durability, innovation, designing and manufacturing related techniques, etc. To this end, a touch panel has been developed as an input device capable of inputting information such as text and graphics, etc.

The touch panel is mounted on the display surface of an image display device such as an electronic organizer, a flat panel display including a liquid crystal display (LCD), a plasma display panel (PDP), an electroluminescence (El) element, or the like, or a cathode ray tube (CRT), so that a user selects desired information while viewing the image display device.

The touch panel is classifiable as a resistive type, a capacitive type, an electromagnetic type, a surface acoustic wave (SAW) type, and an infrared type. The various types of touch panels are used for an electronic product in consideration of not only signal amplification problems, resolution differences and the degree of difficulty of designing and manufacturing technology but also in light of optical properties, electrical properties, mechanical properties, resistance to the environment, input properties, durability and economic benefits. In current, the capacitive type is most prevalently used in a broad range of fields.

In a process for manufacturing a touch panel, when a conductive polymer is used as a transparent electrode, the conductive polymer may be degraded due to thermal and ultraviolet (UV) processes. Sheet resistance of the conductive polymer has been rapidly increased due to a high temperature during a process of forming a dot space in the resistive type touch panel or forming of an Ag electrode wiring in a general touch panel. Reliability of a final product of the touch panel has been deteriorated due to rapid change in the sheet resistance.

### SUMMARY OF THE INVENTION

The present invention has been made in an effort to provide a microcapsule having heat-resistance in which a conductive polymer composing a transparent electrode of a touch panel is formed in a microcapsule structure to improve heat-resistance and electrical reliability, a touch panel containing the same and a method for manufacturing a touch panel.

According to a first preferred embodiment of the present invention, there is provided a microcapsule having heat-resistance, including: a conductive polymer core; and a shell made of polyimide and partially enclosing the conductive polymer core.

The conductive polymer may include poly-3,4-ethylenedioxythiophene/polystyrenesulfonate (PEDOT/PSS), polyaniline, polyacetylene or polyphenylenevinylene.

Content of the polyimide may be 10 to 50 wt % with respect to 100 wt % of the conductive polymer.

The core may have a spherical shape, having a diameter in the range of 10 μm to 50 μm.

According to a second preferred embodiment of the present invention, there is provided a touch panel including: a transparent substrate; and a transparent electrode including a microcapsule having heat-resistance including a conductive polymer core and a shell made of polyimide and partially enclosing the conductive polymer core, and formed on the transparent substrate.

The conductive polymer may include poly-3,4-ethylenedioxythiophene/polystyrenesulfonate (PEDOT/PSS), polyaniline, polyacetylene or polyphenylenevinylene.

Content of the polyimide may be 10 to 50 wt % with respect to 100 wt % of the conductive polymer.

According to a third preferred embodiment of the present invention, there is provided a method for manufacturing a touch panel including a microcapsule, the method including: producing a mixed solution by adding a polyamic acid solution to a solution in which a conductive polymer aqueous solution, polyamic acid, and pyridine are dissolved in a mixed solvent of water and an organic solvent; adding acetic anhydride to the mixed solution and agitating it at a temperature in a range of 50° C. to 90° C. for 1 to 3 hours; and applying the mixed solution subjected to the acetic anhydride addition and agitation to a transparent substrate and then, hardening it at a temperature in a range of 100° C. to 150° C. for 20 to 40 minutes.

The conductive polymer may include poly-3,4-ethylenedioxythiophene/polystyrenesulfonate (PEDOT/PSS), polyaniline, polyacetylene or polyphenylenevinylene.

The polyamic acid, the pyridine, and the acetic anhydride may be mixed in the molar ratio of 1:0.8 to 1.2:0.5 to 1.5.

### BRIEF DESCRIPTION OF THE DRAWINGS

FIG. 1 is a cross-sectional view of a microcapsule in a core-shell structure according to a preferred embodiment of the present invention; and

FIG. 2 is a view showing a process for forming a transparent electrode including a microcapsule according to a preferred embodiment of the present invention.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, in describing the present invention, a detailed description of related known functions or configurations will be omitted so as not to obscure the subject of the present invention.

Hereinafter, preferred embodiments of the present invention will be described in detail with reference to the accompanying drawings.

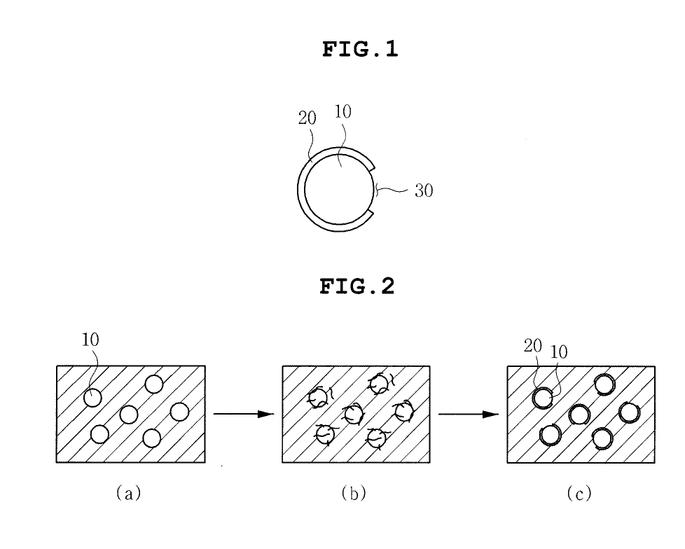

FIG. 1 is a cross-sectional view of a microcapsule in a core-shell structure according to a preferred embodiment of the present invention. A microcapsule having heat-resistance in a core-shell structure according to a preferred embodiment of the present invention is configured to include a conductive polymer core 10 and a shell 20 made of polyimide and partially enclosing the conductive polymer core 10.

A microcapsule does not have an accurate reference to a size; however, indicates a member formed to enclose liquid, solid, or gas molecules with the shell 20, which is a micro container having the size up to several hundred micrometers. The microcapsule may be manufactured to have various sizes from several millimeters to a nanometer according to a manufacturing method thereof. According to a preferred embodiment of the present invention, an electrode of a touch panel is formed using the microcapsule in the core-shell structure, thereby making it possible to improve heat-resistance of the electrode. In order to accomplish this effect, the shell 20 made of a material having the heat-resistance is formed on the conductive polymer; however, it is unstably formed in order to prevent conductivity of the conductive polymer from being reduced. That is, the shell 20 is provided with a partial open region 30 (See FIG. 1) or is formed as a generally thin film, thereby making it possible to maintain the conductivity of the conductive polymer, even after a process such as application of the conductive polymer, etc.

The conductive polymer composing the core 10 may include poly-3,4-ethylenedioxythiophene/polystyrenesulfonate (PEDOT/PSS), polyaniline, polyacetylene or polyphenylenevinylene. However, the conductive polymer composing the core 10 is not necessarily limited thereto but may include various conductive polymer materials. In the case in which the conductive polymer is used as a transparent electrode of the touch panel, thermal deformation may be caused due to a high temperature treatment process, etc., in a process for manufacturing a touch panel. Particularly, a high temperature heat treatment process may be included in a hardening process, etc., in the case of forming a dot space in a resistive type touch panel or in the case of forming an Ag electrode wiring in the resistive type touch panel or a capacitive type touch panel. Problems such as thermal deformation or rapid increase in sheet resistance of the conductive polymer during the high temperature heat treatment process are caused. Therefore, a need exists for a method for improving the heat-resistance of the conductive polymer in order to increase electrical reliability, etc., of the touch panel. In order to improve the heat-resistance, a method for partially forming the shell 20 made of a heat-resistant material on the core-shaped conductive polymer is suggested in the present invention. The core 10 made of the conductive polymer according to a preferred embodiment of the present invention is preferably formed to have a diameter in the range of 10 μm to 50 μm in consideration of electrical conductivity in the case in which it is used as the transparent electrode and the size of the entire microcapsule. However, the core is not necessarily limited to the diameter but may be formed to have various shapes and sizes.

The shell 20 in the core-shell structure is made of the heat-resistant material. This is the reason that the shell 20 for improving the heat-resistance of the conductive polymer composing the core 10 may protect the conductive polymer from a high temperature. The shell 20 in the microcapsule structure may be formed to prevent the core 10 sealed as described above from being damaged and reacting with other material. The core 10 enclosed by the shell 20 may be mainly released by destruction of the shell 20 due to pressure, heating, or the like. However, the shell 20 according to a preferred embodiment of the present invention may be formed to enclose the core 10, while forming the partial open region 30 of the core 10, rather than enclosing the entire core 10. The shell 20 is preferably formed on a partial region of the core 10; however, the core 10 is formed to be thinner than a general thickness of the shell 20, thereby making it possible to form an unstable core-shell structure. The unstable core-shell structure is formed, thereby making it possible to prevent the electrical conductivity of the conductive polymer from being reduced by the shell 20 as well as improve the heat-resistance of the conductive polymer. Since the conductive polymer is used as the transparent electrode of the touch panel, the electrical conductivity thereof is very important. Therefore, the shell 20 is partially destroyed during the process for manufacturing the touch panel or a partial shell 20 is formed on the core 10, thereby making it possible to protect the conductive polymer during the high temperature heat treatment process in the process for manufacturing the touch panel and maintain the conductivity of the conductive polymer. In order to form a partial or a thin unstable shell 20 on the core 10, content of the heat-resistant material composing the shell 20, preferably, is a less amount at a predetermined weight percentage with respect to weight percentage of the conductive polymer composing the core 10. Particularly preferably, the content of the heat-resistant material composing the shell 20 is 10 to 50 wt % with respect to 100 wt % of the conductive polymer composing the core 10. When the content of the heat-resistant material composing the shell 20 is less than 10 wt % with respect to 100 wt % of the conductive polymer composing the core 10, there is a difficulty in forming the shell 20, and when the content of the heat-resistant material composing the shell 20 is more than 50 wt % with respect to 100 wt % of the conductive polymer composing the core 10, the partially shell 20 or the thin shell 20 is not formed on the core 10 and the shell encloses the entire core as in a general microcapsule.

The shell 20 may be made of the heat-resistant material, for example, a polyimide (PI) resin. The polyimide resin has excellent heat-resistance and chemical-resistance characteristics; however, it has a low dielectric constant, such that it may have a negative influence on the electrical conductivity of the conductive polymer. Therefore, in this case, the shell 20 made of the polyimide resin is preferably formed so that the partial open region 30 of the core 10 may be formed. Content of the polyimide resin may be 10 to 50 wt % with respect to 100 wt % of the conductive polymer composing the core 10. In addition, a process temperature is maintained at 100° C. to 150° C., thereby making it possible to perform a control so that the shell 20 made of the polyimide resin may be partially hardened. The microcapsule in the core-shell structure including the shell 20 made of the polyimide resin becomes an unstable state due to the partial hardening. Owing to the unstable state of the shell (20), the partial open region 30 is generated or the shell 20 is formed to have less weight percentage of heat-resistant material than weight percentage of conductive polymer composing the core 10, such that the thin shell 20 is formed, thereby making it possible to protect the core 10 from the high temperature. In addition, when manufacturing of the touch panel is finished, the shell 20 is destroyed or the partial shell 20 is formed, thereby making it possible to maintain the conductivity of the conductive polymer.

The polyimide resin is generally prepared by condensing cycloaliphatic or aromatic tetracarboxylic dianhydride or a derivative thereof and diamine or diisocyanate and then, thermally or chemically imidizing them. Most polyimide resins are prepared by two-step reaction including a first-step reaction in which a polyamic acid resin is prepared by ring opening and polyaddition reaction and a second-step reaction, which is dehydration and cyclization reaction. As a dehydration and cyclization reaction method for preparing the polyimide from the polyamic acid resin, a chemical imidizing method and a thermal imidizing method are typically used.

A method for manufacturing a touch panel including a microcapsule according to a preferred embodiment of the present invention includes producing a mixed solution by adding a polyamic acid solution to a solution in which a conductive polymer aqueous solution, polyamic acid, and pyridine are dissolved in a mixed solvent of water and an organic solvent; adding acetic anhydride to the mixed solution and agitating it at a temperature in a range of 50° C. to 90° C. for 1 to 3 hours; and applying the mixed solution subjected to the acetic anhydride addition and agitation to a transparent substrate and then, hardening it at a temperature in a range of 100° C. to 150° C. for 20 to 40 minutes.

Here, the conductive polymer may include poly-3,4-ethylenedioxythiophene/polystyrenesulfonate (PEDOT/PSS), polyaniline, polyacetylene or polyphenylenevinylene may be used. However, the conductive polymer is not necessarily limited thereto but may include various conductive polymer materials.

The microcapsule is manufactured through a process of dispersing internal materials in a particle state to a medium and then, applying a film thereto. In order to manufacture the microcapsule, three materials are generally required. The required three materials are a material composing the inner core 10 of the microcapsule, a material composing the shell 20 enclosing the inner core 10, and a medium used for manufacturing the microcapsule. Generally, a process for manufacturing the microcapsule includes an emulsion process dispersing the material composing the core 10 of the microcapsule to a dispersion medium having emulsion stability, a process for forming the shell 20 of the microcapsule by agitating an emulsion dispersion solution, and a process for hardening the shell 20 by adding a hardener or a reactant thereto. The microcapsule manufactured through a general process for manufacturing the microcapsule as described above has a structure in which the shell 20 is formed on the entire surface of the core 10. However, according to a preferred embodiment of the present invention, a film of the shell 20 in the core-shell structure should be partially formed on the core 10 or should be formed on the core 10 in an a thin film shaped unstable structure. Therefore, it is necessary to control temperature, time, and the like, of each process. Particularly, in the hardening process, it is important to control the temperature and the time in order to form the unstable shell 20.

Hereinafter, a method for manufacturing a touch panel including a microcapsule according to a preferred embodiment of the present invention will be described with reference to FIG. 2, based on the general process.

FIG. 2 is a view showing a process for forming a transparent electrode including a microcapsule according to a preferred embodiment of the present invention.

In a method for manufacturing a touch panel including a microcapsule according to a preferred embodiment of the present invention, the mixed solution is first produced by adding the polyamic acid solution to the solution in which the conductive polymer aqueous solution, the polyamic acid and the pyridine is dissolved in the mixed solvent of the water and the organic solvent (See FIG. 2A). At the present step, the conductive polymer aqueous solution, the polyamic acid and the pyridine are dissolved in the mixed solvent, and the polyamic acid solution is then gradually added thereto, while the conductive polymer aqueous solution is agitated.

Next, the acetic anhydride is added to the mixed solution and is agitated at a temperature in a range of 50° C. to 90° C. for 1 to 3 hours. In order to produce a mixture of the mixed solution and the acetic anhydride in accordance with the object of the present invention, the mixed solution and the acetic anhydride are preferably agitated at a temperature in a range of 50° C. to 90° C. for 1 to 3 hours. In ranges other than the above-mentioned temperature and time ranges, the material is deformed or appropriate mixture is not performed. Particularly, the mixed solution and the acetic anhydride are preferably agitated at 70° C. for 2 hours (See FIG. 2B).

Then, the mixed solution subjected to the acetic anhydride addition and agitation is applied to the transparent substrate and then hardened at a temperature in a range of 100° C. to 150° C. for 20 to 40 minutes. When the mixed solution is hardened at a temperature of 100° C. or less, there is a difficulty in appropriately forming the shell 20, and when the mixed solution is hardened at a temperature of 150° C. or more, a hardening degree is increased, such that the shell 20 encloses the entire core 10, thereby having a difficulty in manufacturing the microcapsule having heat-resistance in the core-shell structure in accordance with the object of the present invention. In addition, when the mixed solution is hardened for 20 minutes or less, the hardening degree is reduced, thereby having a difficulty in appropriately forming the shell 20, and when the mixed solution is hardened for 40 minutes or more, hardening is further performed, such that the shell 20 encloses the entire core 10, thereby causing reduction in the electrical conductivity of the conductive polymer. Particularly, the mixed solution is preferably hardened at temperature 150° C. for 30 minutes. At the present step, the hardening temperature and time are appropriately controlled, such that the shell 20 in the core-shell structure partially encloses the core 10 or is formed as the thin film to form the unstable core-shell structure (See FIG. 2C). The unstable core-shell structure is formed, thereby making it possible to prevent the conductivity of the conductive polymer composing the core 10 from being reduced. This is the reason that particularly, in the case of using the polyimide resin as the material composing the shell 20, the polyimide resin has the low dielectric constant, such that it may have a negative influence on the electrical conductivity of the conductive polymer, as described above.

The transparent electrode formed on the transparent substrate is hardened, thereby making it possible to manufacture a touch panel including the transparent electrode formed on the transparent substrate. In the method for manufacturing a touch panel including a microcapsule, the polyamic acid, the pyridine, and the acetic anhydride may be mixed in the molar ratio of 1:0.8 to 1.2:0.5 to 1.5. The polyamic acid, the pyridine, and the acetic anhydride may be more preferably mixed in the molar ratio of 1:1:1.2. In the case of mixing the three materials in a ratio other than the above-mentioned mixing ratio, it has an influence on forming a structure in which the shell 20 made of the polyimide encloses the core 10, thereby having a difficulty in normally forming the microcapsule of the core-shell structure.

Results of sheet resistance measurement of the conductive polymer film of the touch panel manufactured by the method for manufacturing a touch panel including a microcapsule as described above and results of repetitive experiments under high temperature and high humidity (about 85° C. and about 85%) environment are shown in following Table 1. Examples indicating the sheet resistance of the conductive polymer film of the touch panel including the microcapsule including the conductive polymer core 10 and the polyimide shell 20 partially formed on the core 10 and a change rate thereof, and Comparative Example indicating the sheet resistance of the conductive polymer film of the touch panel made of the general conductive polymer and a change rate thereof will be provided.

TABLE 1

| | Sheet Resistance(Ω/□) | Change Rate(%) |
|---|---|---|
| Example 1 | 281 | — |
| Example 2 | 290 | 1 |
| Example 3 | 278 | 2 |
| Example 4 | 287 | 2 |
| Example 5 | 291 | 1 |
| Comparative | 285 | 91 |
| Example | | |

As shown in Table 1, according to Examples 1 to 5, it may be appreciated that the sheet resistance of the conductive polymer film including the microcapsule in the core-shell structure in which the polyimide shell 20 is formed does not change or changes at a very small change rate of 1 to 2%. It may be appreciated that the change rates in the sheet resistance in Examples 1 to 5 are significantly reduced as compared to Comparative Example having a change rate exceeding 90%. In addition, it may be appreciated that the conductivity of the conductive polymer is not significantly reduced through the fact that initial sheet resistance values of Examples 1 to 5 in which the shell 20 is formed is similar to that of Comparative Example in which the shell 20 is not formed. That is, in the core-shell structure according to the preferred embodiment of the present invention, the shell 20 is partially or thinly formed on the core 10 to be unstably formed, thereby not reducing electrical characteristics of the conductive polymer.

According to the preferred embodiment of the present invention, the core-shell structure in which a partial polyimide shell is formed on the conductive polymer core is formed, thereby making it possible to improve the heat-resistance of the conductive polymer.

In addition, the transparent electrode having improved heat-resistance is used to minimize a change rate in sheet resistance due to a high temperature, such that the electrical reliability of the touch panel is improved, thereby making it possible to improve accuracy of an operation.

Although the preferred embodiments of the present invention have been disclosed for illustrative purposes, they are for specifically explaining the present invention and thus a microcapsule having heat-resistance, a touch panel containing the same and a method for manufacturing a touch panel according to the present invention are not limited thereto, but those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A microcapsule having heat-resistance comprising:
a conductive polymer core; and
a shell made of polyimide and partially enclosing the conductive polymer core.

2. The microcapsule having heat-resistance as set forth in claim 1, wherein the conductive polymer includes poly-3,4-ethylenedioxythiophene/polystyrenesulfonate (PEDOT/PSS), polyaniline, polyacetylene or polyphenylenevinylene.

3. The microcapsule having heat-resistance as set forth in claim 1, wherein content of the polyimide is 10 to 50 wt % with respect to 100 wt % of the conductive polymer.

4. The microcapsule having heat-resistance as set forth in claim 1, wherein the core has a spherical shape, having a diameter in the range of 10 μm to 50 μm.

5. A touch panel comprising:
a transparent substrate; and
a transparent electrode including a microcapsule having heat-resistance including a conductive polymer core and a shell made of polyimide and partially enclosing the conductive polymer core, and formed on the transparent substrate.

6. The touch panel as set forth in claim 5, wherein the conductive polymer includes poly-3,4-ethylenedioxythiophene/polystyrenesulfonate (PEDOT/PSS), polyaniline, polyacetylene or polyphenylenevinylene.

7. The touch panel as set forth in claim 5, wherein content of the polyimide is 10 to 50 wt % with respect to 100 wt % of the conductive polymer.

8. A method for manufacturing a touch panel including a microcapsule, the method comprising:
producing a mixed solution by adding a polyamic acid solution to a solution in which a conductive polymer aqueous solution, polyamic acid, and pyridine are dissolved in a mixed solvent of water and an organic solvent;
adding acetic anhydride to the mixed solution and agitating it at a temperature in a range of 50° C. to 90° C. for 1 to 3 hours; and
applying the mixed solution subjected to the acetic anhydride addition and agitation to a transparent substrate and then, hardening it at a temperature in a range of 100° C. to 150° C. for 20 to 40 minutes.

9. The method as set forth in claim 8, wherein the conductive polymer includes poly-3,4-ethylenedioxythiophene/polystyrenesulfonate (PEDOT/PSS), polyaniline, polyacetylene or polyphenylenevinylene.

10. The method as set forth in claim 8, wherein the polyamic acid, the pyridine, and the acetic anhydride are mixed in the molar ratio of 1:0.8 to 1.2:0.5 to 1.5.
